(19) United States
(12) Patent Application Publication
(10) Pub. No.: US 2015/0213420 A1
(43) Pub. Date: Jul. 30, 2015

(54) METHOD AND DEVICE FOR DETERMINING VEHICLE CONDITION BASED ON OPERATIONAL FACTORS

(71) Applicant: Nissan North America, Inc., Franklin, TN (US)

(72) Inventors: Vikram Krishnamurthy, Smyrna, GA (US); Larry Haddad, Rancho Palos Verdes, CA (US); Toshiro Muramatsu, Sunnyvale, CA (US); Daisuke Saito, Sunnyvale, CA (US)

(73) Assignee: Nissan North America, Inc., Franklin, TN (US)

(21) Appl. No.: 14/166,017

(22) Filed: Jan. 28, 2014

(51) Int. Cl. G06Q 20/10; G07C 5/00; G06Q 30/06

(52) U.S. Cl. CPC G06Q 20/10; G06Q 30/06; G07C 5/00; G07C 5/008

(57) ABSTRACT

Methods and apparatus are provided for monitoring a vehicle, and in particular, for monitoring a vehicle to determine a vehicle condition based on operational factors to incentivize or penalize a driver. One method of monitoring a vehicle comprises providing the vehicle to a driver for a term, the vehicle associated with a base vehicle condition, collecting operational data of the vehicle during the term, manipulating the operational data of the vehicle periodically throughout the term to arrive at an updated vehicle condition and providing an incentive or a penalty to the driver based on the updated vehicle condition.

### TECHNICAL FIELD

This disclosure relates to methods for determining a vehicle condition based on operational factors that impact the vehicle condition, and in particular, to extrapolate a vehicle condition from the operational factors to incentivize a driver.

### BACKGROUND

When leasing a vehicle, the monthly payment is determined at the beginning of the term of the lease and is based on a plurality of factors. Typically, monthly lease payments are determined by the manufacturers' suggested retail price (MSRP), the annual percentage rate (APR), the term of the lease, and the residual value of the vehicle at the end of the lease term. The residual value of the vehicle depends on a number of factors including, but not limited, to the make and model of the vehicle. As examples, for thirty-six month leases, the residual value is typically around fifty percent and for forty-eight month leases, the residual value is typically around forty percent. Various calculators, such as cars.com, Automotive Lease Guide and the like, can be used to determine the residual value of a vehicle, with such residual value used to determine a lessee's monthly payment.

### SUMMARY

Disclosed herein are methods and apparatus for monitoring a vehicle, and in particular monitoring operational factors of a vehicle to determine a vehicle condition that will be used to incentivize or penalize a driver.

One such method of monitoring a vehicle disclosed herein comprises providing the vehicle to a driver for a term, the vehicle associated with a base vehicle condition, collecting operational data of the vehicle during the term, manipulating the operational data of the vehicle periodically throughout the term to arrive at an updated vehicle condition and providing an incentive or a penalty to the driver based on the updated vehicle condition.

An apparatus for monitoring a vehicle provided to a driver for a term comprises a memory and a processor configured to execute instructions stored in the memory to collect operational data of the vehicle during the term, manipulate the operational data of the vehicle periodically throughout the term to arrive at an updated vehicle condition and provide an incentive or a penalty to the driver based on the updated vehicle.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a flow diagram of a method disclosed herein of monitoring a vehicle;

FIG. 2 is a schematic block diagram of an example of a system for generating vehicle data and recording the vehicle data for evaluation, showing a data center and a vehicle with a telematics control unit (TCU) for communicating vehicle data to the data center;

FIG. 3 is a schematic of the vehicle condition categories collected by the TCU for evaluation;

FIG. 4 is a flow diagram of a method of determining the effective interest rate for a period of a term such as a lease;

FIG. 5 is a flow diagram for determining a weighted value for a vehicle condition category;

FIG. 6 is a flow diagram for determining a weighted value for another vehicle condition category;

FIG. 7 is a flow diagram for determining a weighted value for another vehicle condition category;

FIG. 8 is a flow diagram for determining a weighted value for another vehicle condition category; and

FIG. 9 is a flow diagram for determining an extrapolated vehicle condition as disclosed herein.

### DETAILED DESCRIPTION

The residual value of the vehicle is determined at the outset of a lease term and used to determine the monthly payments that the lessee will make throughout the term. The higher the residual value, the lower the monthly payments. Many factors used to determine the residual value of a vehicle are not within the control of a lessee.

However, the residual value of the vehicle is affected by the lessee's behavior over the term of the lease. If the behavior of the lessee over the term of the lease results in a higher residual value than that calculated at the beginning of the term, the lessor is awarded with property worth more than the anticipated amount. For example, if the lessee performed proper maintenance, drove conservatively, washed the vehicle weekly, the condition of the vehicle may be better than the condition determined from the factors used in the residual value calculation, resulting in a vehicle having a higher monetary worth at the end of the lease. The lessor can sell the vehicle for a higher amount than the amount estimated at the beginning of the lease. The lessor keeps this additional revenue, while the revenue already paid by the lessee is unaffected. The increase in residual value has no effect on the monthly payments that the lessee made throughout the term.

If the behavior of the lessee over the term of the lease results in a lower residual value than that calculated at the beginning of the term, the lessor is financially harmed as its property is worth less than the anticipated amount. For example, if the lessee did not maintain the vehicle, left the vehicle outside constantly, failed to upkeep the interior of the vehicle, the condition of the vehicle may be worse than the condition determined from the factors used in the residual value calculation, resulting in a vehicle having a lower monetary worth at the end of the lease. The lessor can only sell the vehicle for a lessor amount than the amount estimated at the beginning of the lease. The lessor loses this revenue, while the revenue already paid by the lessee is unaffected. Again, the change in residual value has no effect on the monthly payments that the lessee made throughout the term.

Incentivizing a lessee's behavior over the term of the lease can be beneficial to both the lessor and lessee. One such incentive is a reduction in periodic lease payments if lessee behavior meets certain criteria. Disclosed herein are methods of monitoring a vehicle and the vehicle lessee's behavior to enable provision of such incentives over the course of a lease.

Although the methods are discussed in terms of a lease vehicle, the methods are not limited to a leased vehicle. The methods can also be applied to rental vehicles and other situations in which a vehicle is not purchased outright but rather used for a term and paid for on a periodic basis during the term by a driver that is not the owner. As used herein, the term “driver” refers to the lessee, renter or such who is signing for and using the vehicle for the term. As used herein, the term “behavior” refers to the driver's treatment of the vehicle, both operation and non-operational.

When a driver leases a vehicle, the periodic payment is determined at the beginning of the term of the lease and is based on a plurality of factors. Typically, lease payments are determined by the MSRP (which addresses such factors as the make of the vehicle, the model of the vehicle, the year of the vehicle), the interest rate, the term of the lease, and the residual value of the vehicle at the end of the lease term. The residual value is typically calculated using the following parameters: the sales location, the consumer demand of the vehicle, incentives and marketing for the vehicle, inventory management of the vehicle, lease type and terms and others.

In addition, the vehicle condition at the end of the lease can have a significant impact on the residual value. If all factors used to determine residual value for two vehicles of the same make, model and year are the same or equal, the vehicle in the better condition at the end of the lease will have a higher residual value. However, the vehicle condition at the end of a lease is very difficult to estimate as the vehicle condition is directly related to the driver's behavior.

If a driver elects to be monitored, i.e., participate in the incentive program, this election can be a factor in determining the residual value, along with the driver's characteristics, such as age, salary, credit rating, home ownership or rental, marital status, driving record and others. The residual value can be formulated as a variance from the typical residual value calculators. This variance, based on the driver's election to participate in the monitoring program and the driver's characteristics, will indicate the likelihood that the driver will exercise positive behavior throughout the term of the lease. As noted above, the periodic payment is determined by the initial value of the car, the residual value of the car at the end of the lease, the duration of the lease, and the interest rate. If the residual value of the car at the end of the lease is extrapolated to be higher than average due to the driver's characteristics and election to participate in the monitoring program, the periodic payments will decrease even with the interest rate unchanged. Therefore, the base periodic payments can be lower for a driver participating in the monitoring program than for a driver who does not elect to participate.

It should be noted that this original reduction in periodic payments is not necessary and can or cannot be used in conjunction with the reductions calculated during the monitoring program.

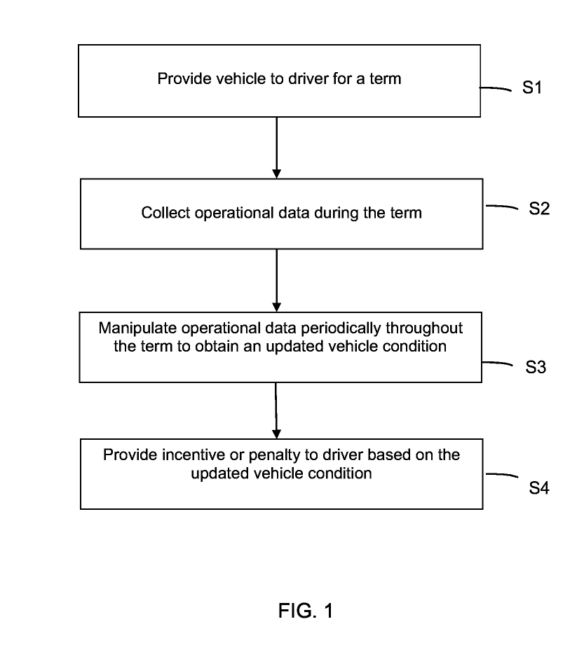

The monitoring program, as illustrated in FIG. 1, can comprise first providing the vehicle to a driver for a term in step S1, the vehicle associated with a base vehicle condition. Operational data of the vehicle is collected during the term in step S2. The operational data of the vehicle is manipulated periodically throughout the term in step S3 to arrive at an updated vehicle condition. An incentive or a penalty is provided to the driver based on the updated vehicle condition in step S4. These steps will be described in greater detail herein.

By being monitored throughout the term of the lease, the driver will be eligible for additional periodic payment decreases, such as a reduction in the effective interest rate, throughout the monitored term. This decrease will be realized if the monitored vehicle conditions resulting from the driver's behavior have a positive effect on an extrapolated residual value of the vehicle. The extrapolated residual value at the end of the lease term is extrapolated periodically throughout the term using the vehicle condition data that is continuously collected and extrapolated to adjust the previously determined residual value to calculate the periodic discount. As used herein, the term “vehicle condition” refers to any operational or non-operational characteristic of the vehicle that can be affected by the driver's behavior. A base-line vehicle condition at the end of the term is designated to determine the initial residual value used to calculate the initial periodic payment.

To estimate the vehicle condition used in calculating the extrapolated residual value throughout the term of the lease, the key factors that should be monitored include: maintenance of the vehicle exterior, environmental/geographic factors, driving style and vehicle system history and maintenance. The vehicle condition can be monitored throughout the term using multiple sensors and the like as will be described in further detail below. The data can be collected by any type of data logging device, such as, but not limited to, a telematics control unit (TCU), tethered cell phone, secure digital memory cards, on-board diagnostic systems, or any combination thereof.

Maintenance of the Vehicle Exterior:

One non-operational factor that impacts the maintenance of the vehicle exterior, and thus the vehicle condition, is the frequency or percentage of time in a given period that the driver parks the vehicle in an enclosed structure such as a garage or parking deck. The longer the amount of time a vehicle is parked in an enclosed structure, the greater the likelihood that the exterior of the vehicle will be in good condition. When parked in an enclosed structure, the vehicle is protected from sun, wind debris, rain, hail, snow, other falling objects and the like.

Determining the percentage of time that the vehicle is parked in an enclosed structure is performed using a unique algorithm using vehicle global positioning system (GPS) data, alone or with other sensors, as disclosed in U.S. patent application Ser. No. 14/165,686, the entirety of which is incorporated herein by reference. In one example, a recognized terminus of a route traveled by the vehicle could be correlated to a parking event in an enclosed structure for the vehicle only if the vehicle was located at the terminus for a predetermined period of time and/or within a specified time window. In another example, a recognized terminus of a route traveled by the vehicle could be correlated to a parking event in an enclosed structure only if the terminus corresponds in location to a home address, work address or other address for the driver of the vehicle. An address of interest may be identified on the basis of public records and/or private records associated with the driver. Alternatively, an address could be identified by analyzing patterns within the navigation data. A home address, for instance, could be identified at a location that the vehicle routinely leaves from and arrives to. For a typical driver, this location could be for example a location that the vehicle routinely leaves from in the morning and arrives to at night on weekdays. Although an identification of a home address is explained in accordance with one example, it will be understood that other addresses of interest could be identified on the basis of the navigation data for the vehicle.

Another factor that impacts the maintenance of the vehicle exterior, and thus the vehicle condition, is the frequency that the vehicle is taken to a car wash. The more frequent a vehicle is taken to a car wash, the greater the likelihood that the exterior of the vehicle will be in good condition.

The frequency or number of times a vehicle is taken to a car wash can be determined by comparing GPS data taken from the vehicle and comparing it to nearby locations of a car wash, as disclosed in U.S. patent application Ser. No. 14/165,753, which is incorporated herein in its entirety.

Environmental/Geographic Factors:

Environmental and geographic factors are non-operational factors that impact the vehicle condition and in particular impact the wear on the exterior body of the vehicle. Weather occurring in the vehicle's GPS location can be monitored, logging when the vehicle is in a snow storm, hail storm, tropical storm, ice storm, etc., as non-limiting examples.

Windshield wiper usage data can be monitored, such as duration of use and speed of wipers, to determine the amount of time the vehicle was exposed to wet or icy conditions.

An optical sensor can be used on the vehicle to determine the amount of sunlight to which the vehicle is exposed. Excessive and/or intense sunlight can cause fading to the exterior vehicle paint.

The geographic location of the vehicle can be monitored to extrapolate the vehicle condition. For example, a seaside location may cause accelerated erosion of the car exterior. As another example, winter/cold locations where salt spreading is typical may accelerate corrosion of the car exterior. The vehicle can also be equipped with atmosphere sensors, which can measure the air condition outside, such as carbon dioxide, NOx, Sox, pH of rain, etc.

Driving Style:

The driver's driving style impacts the vehicle condition. The following are non-limiting examples of driving conditions that are operational factors that can be monitored to determine the vehicle condition for extrapolation of the residual value. These factors can be obtained, for example, from TCU data.
The number of miles driving, relating to engine wear as well as potential for an accident;
The number of times the engine is started and stopped, relating to engine wear;
The number of sudden acceleration and deceleration, relating to engine wear as well as potential for an accident;
Ratio of highway versus city driving, using, for example, speed versus time data, also relating to engine wear as well as potential for an accident;
Amount of night time driving, relating to the probability of an accident;
Amount or frequency of excessive G-forces on the vehicle, or excessive lateral acceleration, relating to dangerous driving behavior and probability of an accident; and
Amount or frequency of erratic steering, relating to dangerous driving behavior and probability of an accident.

Vehicle System History/Maintenance:

The vehicle system history and vehicle maintenance are operational factors that impact the vehicle condition. In addition to monitoring vehicle service records, many vehicle system parameters can be measured with, for example, the vehicle TCU, to predict vehicle system failures and/or premature wear to determine the vehicle condition for extrapolation of the residual value.

The three most common causes of internal combustion engine problems are overheating, spark knock, and low engine oil levels. Examples of key parameters that can predict these common vehicle system issues are:
Engine temperature determined from engine coolant temperature;
Air-fuel mixture determined from an oxygen sensor;
Ignition timing determined by ignition timing advance; and
Oil level inferred from oil temperature sensor.
Frequency and duration that check engine light is on before being serviced; and
Frequency and duration of other warning lights remaining on before being serviced.

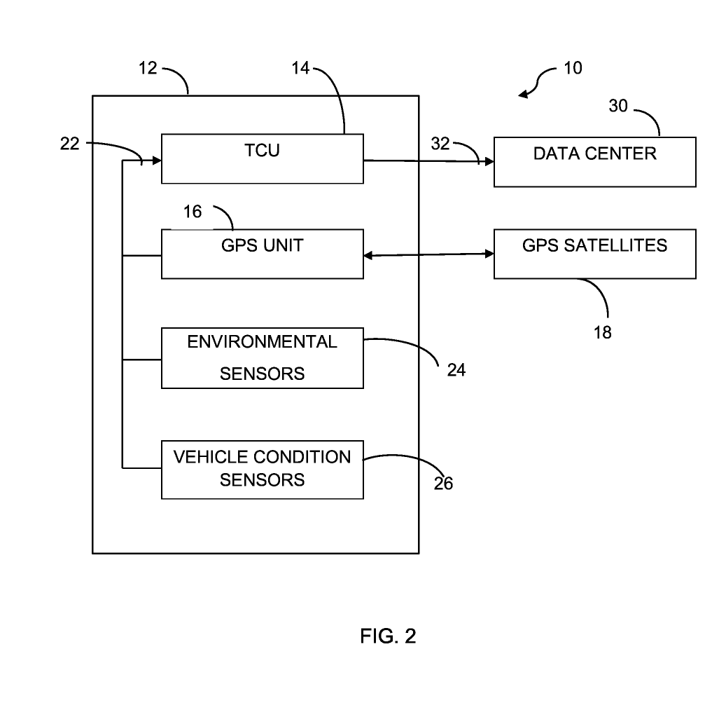

The factors discussed above impacting the vehicle condition can be monitored and the data collected using the methods described. FIG. 2 is a schematic representation of an example of a system 10 for use in collecting and recording vehicle condition data from a vehicle 12 for further evaluation. In the example system 10, the vehicle 12 has a TCU 14 on board configured to control tracking of the vehicle 12 and vehicle conditions. The vehicle 12 is generally configured to support the generation of navigation data for the vehicle 12. As shown, the vehicle 12 is equipped with a GPS unit 16. The GPS unit 16 is communicatively coupled to a plurality of GPS satellites 18 over a communications channel 20. The communication channel 20 may be a wireless channel, for example, using a standard or proprietary protocol. The GPS satellites 18 may generally be configured to communicate signals to the GPS unit 16 that permit the position of the GPS unit 16, and by extension the vehicle 12, to be determined. In a non-limiting example, the position of the vehicle 12 may be associated with a coordinate system, such as a geographic coordinate system, for instance, that specifies position with reference to a latitude and longitude.

The TCU 14 is communicatively coupled to the GPS unit 16 over a communications channel 22. The communication channel 22 may be a wired or wireless channel configured to allow for sharing of information, data and/or computing resources between the GPS unit 16 and the TCU 14. The GPS unit 16, the TCU 14 and optionally, other devices, may be configured with respective hardware and software so that collectively signals may be received from the GPS satellites 18, multiple positions of the vehicle 12 over a period of time may be determined, and corresponding GPS navigation data for the vehicle 12 (i.e., navigation data originating from communication between the GPS unit 14 and the GPS satellites 16) may be stored in memory.

The TCU 14 may be one or multiple computers including a random access memory (RAM), a read-only memory (ROM) and a central processing unit (CPU) in addition to various input and output connections. Generally, the control functions of the vehicle 12 described herein can be implemented by one or more software programs stored in internal or external memory and are performed by execution by the respective CPUs of the TCU 14. However, some or all of the functions could also be implemented by hardware components. Although the GPS unit 16 and the TCU 14 are shown as separate units and described as performing respective operations, it will be understood that the operational aspects of the GPS unit 16 and the TCU 14 may be distributed differently than as specifically described.

As shown in FIG. 2, the vehicle 12 may be equipped with one or more environmental sensors 24 for supporting the generation of environmental data for the vehicle 12. The environmental sensors 24 could be or include, for instance, an optical sensor or an atmosphere sensor. The vehicle 12 may be equipped with vehicle condition sensors 26 for sensing or otherwise indicating any variety of conditions of the vehicle 12 discussed above. The corresponding vehicle condition data can concern a variety of operational aspects of the vehicle 12, such as whether the vehicle 12 is powered on or off, for instance. The environmental data and vehicle condition data sensed or otherwise indicated by the environmental sensors 24 and vehicle condition sensors 26 can be communicated to the TCU 14 as generally shown.

In the example system 10, any available data for the vehicle 12 may be correlated to a time element and transmitted by the TCU 14 to a remote data center 30 over a wireless communications channel 32 for evaluation, for example, by a vehicle manufacturer or dealer or a financial institution to determine the extrapolated residual value at any given time. As used herein, the term “data center” refers to a location external to the vehicle 12 to which data is transferred for further processing.

Determining the Extrapolated Residual Value:

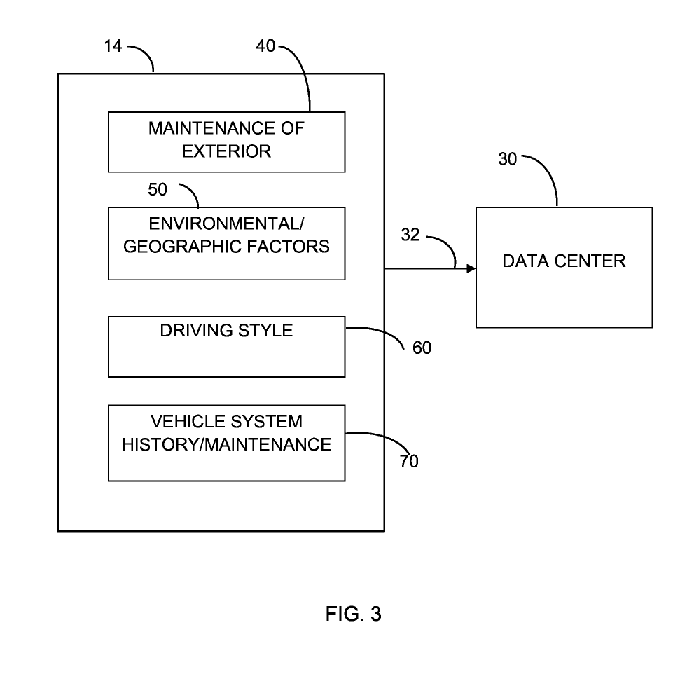

FIG. 3 is a schematic of the TCU 14 with collected data in the following categories: maintenance of the exterior 40, environmental/geographic factors 50, driving style 60 and vehicle system history/maintenance 70. It is noted that these categories are provided for illustration of the methods and devices herein. The categories and data within the categories can be altered to achieve the desired or required results while remaining within the spirit and scope of the claims. Some or all of the categories and some, none or all of the data within the categories can be collected by the TCU 14 and some or all of the categories and some, none or all of the data within the categories can be used to determine the extrapolated residual value.

The data is sent from the TCU 14 to the data center 30 to manipulate the data and determine the extrapolated residual value. Alternatively, the manipulation and determination of the extrapolated residual value can be performed by the TCU 14 and communicated to the data center 30. The data can be communicated to the data center 30 continuously as collected, at specific time intervals or when requested. The data can be processed as frequently as desired or required. In the examples herein, the data is calculated once per period to determine an extrapolated residual value per period. As used herein, the term “period” can refer to, for example, the amount of time between lease payments, which is typically one month. However, the period can be any period of time desired and will likely be determined by the user of the extrapolated residual value (i.e., dealer or financial institution).

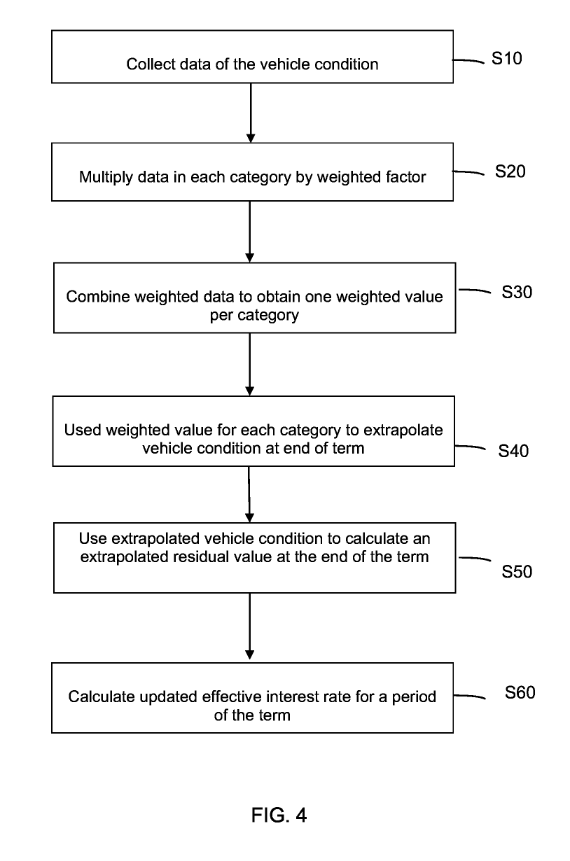

The process of determining the extrapolated residual value is illustrated in FIG. 4. The data is collected for the vehicle condition in the multiple categories by the TCU 14 in step S10. The data in each category is multiplied by a weighted factor in step S20, and the weighted data in each category is combined to arrive at a single weighted value per category in step S30. FIGS. 4-7 are flow diagrams of the process of arriving at the weighted value for each category.

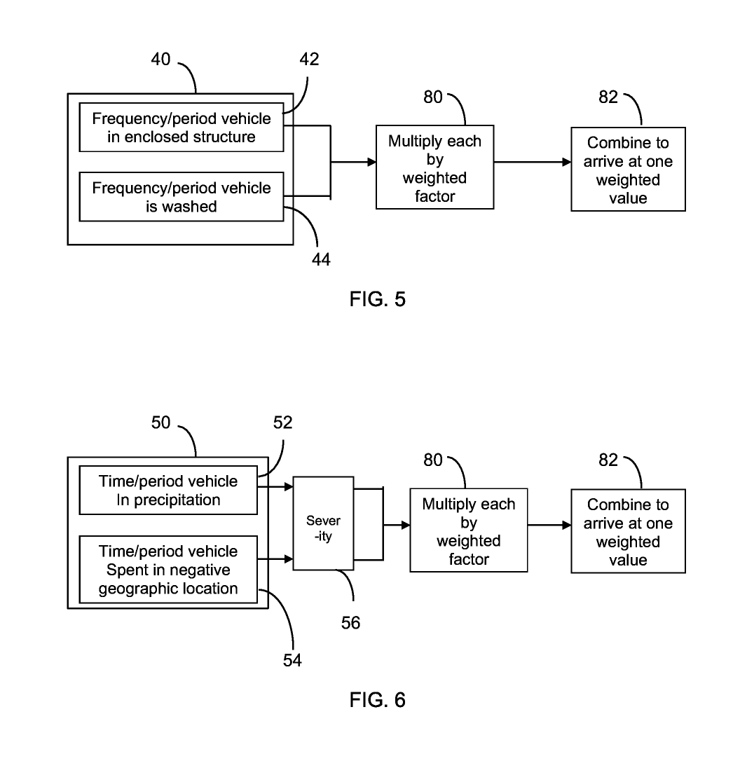

In FIG. 5, the representative data for the maintenance of the exterior category 40 includes the frequency per period that the vehicle was kept in an enclosed structure 42 and the frequency per period the vehicle went through a car wash 44. The representative data 42, 44 is each multiplied by a weighted factor 80 and each weighted factor 80 is combined to arrive at one weighted value 82 for the maintenance of the exterior category 40. The weighted factors for data 42, 44 may be universal factors for each data 42, 44, or may vary depending on, for example, the part of the country in which the driver is located. The location may change the factor based on climate or based on urban/rural distinctions, as non-limiting examples.

In FIG. 6, the representative data for the environmental/geographic factors category 50 includes the time per period the vehicle was exposed to precipitation 52 and the time per period the vehicle spent in a negative geographic location 54. The representative data can optionally be pre-weighted 56 based on the type of precipitation and the actual geographic location to account for variance in severity. For example, time spent in hail may be given more weight than time spent in rain. The representative data 52, 54 is each multiplied by a weighted factor 80 and each weighted factor 80 is combined to arrive at one weighted value 82 for the environmental/geographical factors category 50.

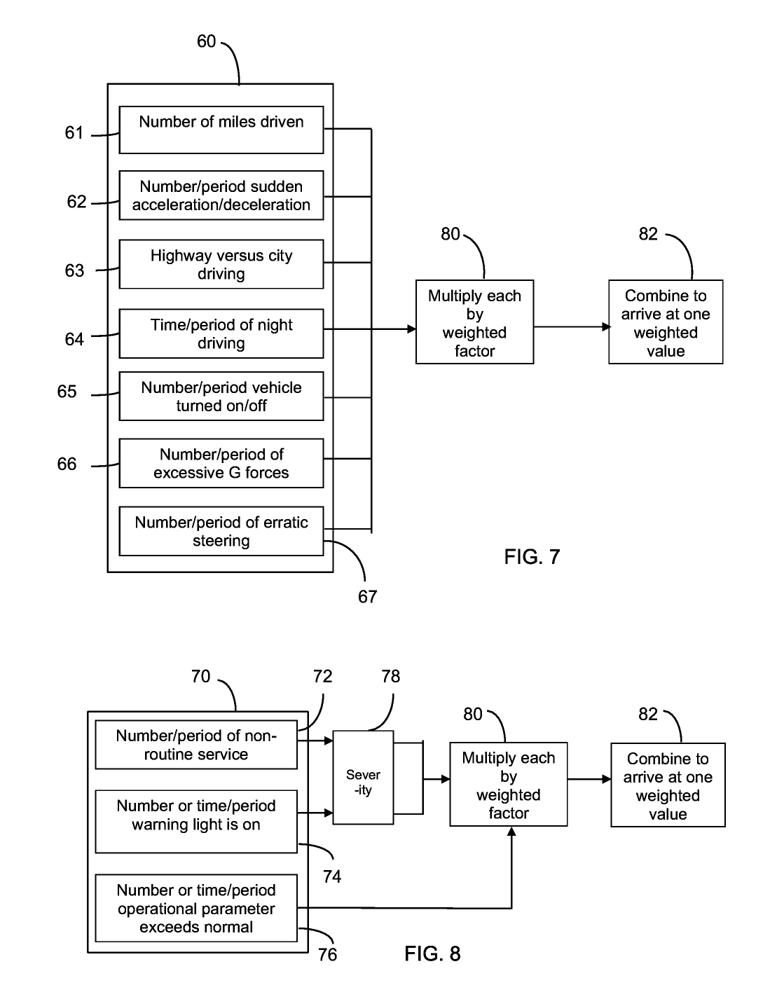

In FIG. 7, the representative data for the driving style category 60 includes the following: number of miles driven 61, number per period of sudden acceleration or deceleration 62, amount of highway driving versus city driving 63, time per period the vehicle was driven at night 64, number per period the vehicle was turned on and off 65, the number per period the vehicle experienced excessive G forces 66, and the number per period the vehicle experienced erratic steering. The representative data 61, 62, 63, 64, 65, 66 is each multiplied by a weighted factor 80 and each weighted factor 80 is combined to arrive at one weighted value 82 for the driving style category 60. It is noted that the format in which the data provided in each of the FIGS. 4-7 is provided by way of illustration and is not meant to be limiting. For example, highway driving versus city driving can be presented in a ratio, an amount of time each occurred, or an average speed of the vehicle over the period.

In FIG. 8, the representative data for the vehicle system history/maintenance category 70 includes the number or time per period that operational parameters exceed a normal range 76, the number per period that non-routine service is performed on the vehicle 72 and the number or time per period the warning light is on 74. The representative data 72, 74 can optionally be pre-weighted 78 based on the type of warning light or type of non-routine maintenance received to account for variances in severity. The representative data 72, 74, 76 is each multiplied by a weighted factor 80 and each weighted factor 80 is combined to arrive at one weighted value 82 for the vehicle system history/maintenance category 70.

As discussed, the weighted values 82 are determined using data from a period of time. For example, if a vehicle lease requires monthly payments, the weighted values 82 can be calculated once per month to be used in extrapolation of the residual value. The data used can be data from the prior month, so that there is a weighted value 82 for each category 40, 50, 60, 70 for each period. The data used can also be data from the beginning of the lease contract through the end of the month prior to calculation.

Returning to FIG. 4, the weighted values 82 are used to extrapolate a vehicle condition at the end of the term (e.g., lease term) in step S40, with the extrapolated vehicle condition used to calculate an extrapolated residual value in step S50. The extrapolated residual value is then used to calculate an updated effective interest rate to be applied to the lease, for example, for the period following the calculation in step S60. If the extrapolated vehicle condition is above the base condition used to determine the initial residual value, the extrapolated residual value will increase, thereby reducing the effective interest rate for a period of the lease, reducing the periodic payment for at least that period.

Any method known to those skilled in the art can be used to extrapolate the vehicle condition using the weighted value 82 of each category 40, 50, 60, 70. As non-limiting examples, regression methods and/or machine learning methods can be used. One method will be described herein for illustrative purposes, but the use of other methods is contemplated.

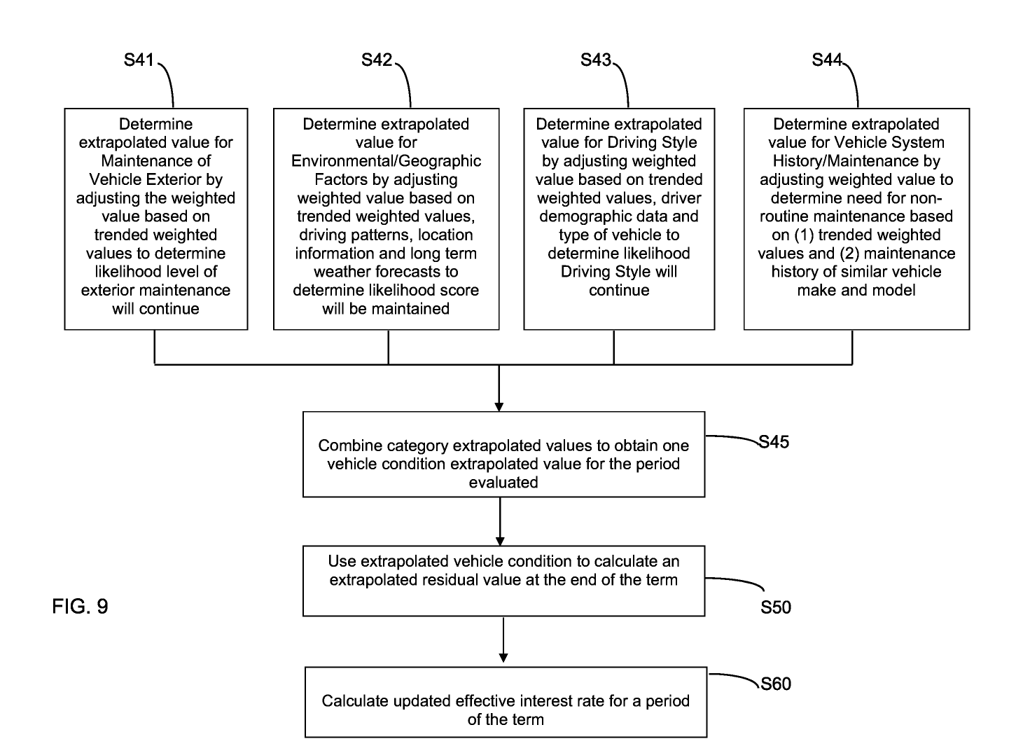

FIG. 9 is a flow diagram of a method of extrapolating the weighted values for each of the vehicle condition categories shown in FIG. 5, step S40, to arrive at an extrapolated vehicle condition. As illustrated in steps S41-S44, each of the weighted values for a respective vehicle condition category is extrapolated to obtain an extrapolated vehicle condition at the end of the term used to determine the extrapolated residual value.

In step S41, the weighted value of the Maintenance of the Vehicle Exterior category 40 is adjusted based on previously calculated weighted values and trended to determine the likelihood that the trend will continue. For example, if the trend is flat, it is likely that the driver will continue to park in an enclosed structure and visit a car wash with a similar frequency as previously determined. If the weighted values for previous periods of category 40 are above average, the extrapolated value for the Maintenance of the Vehicle Exterior category 40 will be above average.

In step S42, the weighted value of the Environmental/Geographic Factor category 50 is adjusted based on trended weighted values, driving patterns, location information and long term weather forecasts to determine the extrapolated value for the category 50. For example, a driver's driving pattern may indicate that the driver has gone to the seaside once per month in previous periods. The likelihood that the driver will continue this pattern is high. Long term weather information can be used to determine if a vehicle will be subjected to a change in weather. The trend may indicate that the vehicle is regularly subjected to a specific amount of precipitation; however, the long range forecast may indicate that the region in which the driver is located will experience unusually high amounts of precipitation in the future. This information can be used to alter the trend data to more accurately extrapolate the value for the category 50.

In step S43, the weighted value of the Driving Style category 60 is adjusted based on trended weighted values, driver demographic data and the type of vehicle to determine the extrapolated value for the category 60. For example, if the weighted value indicates that the driver's driving style is above average, the driver is between 40 and 50 years of age and uses the vehicle mostly to drive to a work location and home, and the vehicle is a four door sedan, the likelihood that the driver's driving style weighted average will remain above average is high.

In step S44, the weighted value of the Vehicle System History/Maintenance category 70 is adjusted based on trended weighted values and the maintenance history of similar vehicle makes and models to determine the likelihood of the need for non-routine maintenance over the remainder of the term.

In step S45, the extrapolated values for each category are combined to obtain one extrapolated vehicle condition value representing the vehicle condition at the end of the term. There are many methods of combining the extrapolated category values to arrive at a single vehicle condition extrapolated value. As a non-limiting example, a weighting factor can be assigned to each of the categories, the extrapolated value for each category can be multiplied by its respective weighting factor and the weighted extrapolated values totaled to arrive at the extrapolated vehicle condition value.

The extrapolated vehicle condition value will be used to calculate an extrapolated residual value in step S50. For example, the extrapolated vehicle condition value can be compared to the base-line vehicle condition value and assigned a rating that indicates how the extrapolated vehicle condition value is different. The rating can be numerical, alphabetic or any other label desired or required. The rating can indicate that the extrapolated vehicle condition value is above-average, average or below-average, with the base-line value also being average. The rating can be a percentage scale, with the extrapolated vehicle condition value assigned a positive percentage from 1 to 100% for the degree in which the extrapolated vehicle condition is better than the base-line or a negative percentage from −1 to −100% for the degree in which the extrapolated vehicle condition is below the base-line. If the base-line vehicle condition is designated a value of 50, an extrapolated vehicle condition rating of 50% would result in an extrapolated vehicle condition value of 75 to be used in calculating the extrapolated residual value. The extrapolated residual value will be higher than the initially calculated residual value because the vehicle condition value has increased.

In step S60, the effective interest rate for the period is calculated using the extrapolated residual value. For example, a driver has a 36 month lease and is participating in the monitoring program. At the beginning of the lease, the effective interest rate was determined to be 7% based on the residual value determined using the factors described herein and the base-line vehicle condition. The program continuously monitors the data in the categories 40, 50, 60, 70 described herein for three months. At the end of the three months, an updated effective interest rate is calculated as described herein based on the extrapolated residual value, which is extrapolated based on three months of data. The updated effective interest rate is 6.7%. Therefore, for the next three months of the lease, the driver's monthly payment decreases based on the decrease in effective interest rate. After six months, the calculations are performed using six months of data. Because the driver is incentivized to take good care of the vehicle due to the decrease in his monthly payments, the extrapolated residual value increases further based on the six months of data. The updated effective interest rate is now 6.5%. Therefore, for the next three months of the lease, the driver's monthly payment is further decreased.

The owner of the vehicle benefits financially from the program. The owner will generate additional revenue from a higher residual value for the vehicle at the end of the term due to the improved vehicle condition at the end of the term.

The owner can also generate additional revenue by retaining a certain percentage of the discount in the periodic payments obtained by the increased residual value of the vehicle. Using the example above, if the effective interest rate for a driver decreased from 7% to 6.7% based on the extrapolated residual value, the driver may be provided with monthly payment reductions based on 6.85% interest rate, or 50% of the available reduction, with the owner holding back the 0.15% reduction for itself.

Implementations of computing devices used by the TCU or data center to carry out the processes (and the algorithms, methods, instructions, etc., stored thereon and/or executed thereby as described herein) may be realized in hardware, software, or any combination thereof. The hardware can include, for example, computers, IP cores, ASICs, PLAs, optical processors, PLCs, microcode, microcontrollers, servers, microprocessors, digital signal processors or any other suitable circuit. In the claims, the term “processor” should be understood as encompassing any of the foregoing hardware or other like components to be developed, either singly or in combination.

In one example, a computing device may be implemented using a general purpose computer or general purpose processor with a computer program that, when executed, carries out any of the respective methods, algorithms and/or instructions described herein. In addition or alternatively, for example, a special purpose computer/processor can be utilized which can contain other hardware for carrying out any of the methods, algorithms, or instructions described herein. Further, some or all of the teachings herein may take the form of a computer program product accessible from, for example, a tangible (i.e., non-transitory) computer-usable or computer-readable medium. A computer-usable or computer-readable medium is any device that can, for example, tangibly contain, store, communicate, or transport the program for use by or in connection with any processor. The medium may be an electronic, magnetic, optical, electromagnetic or semiconductor device, for example.

As described herein, the processes include a series of steps. Unless otherwise indicated, the steps described may be processed in different orders, including in parallel. Moreover, steps other than those described may be included in certain implementations, or described steps may be omitted or combined, and not depart from the teachings herein.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of monitoring a vehicle comprising:
providing the vehicle to a driver for a term, the vehicle associated with a base vehicle condition;
collecting operational data of the vehicle during the term;
manipulating the operational data of the vehicle periodically throughout the term to arrive at an updated vehicle condition; and
providing an incentive or a penalty to the driver based on the updated vehicle condition.

2. The method of claim 1, wherein collecting the operational data is performed by a telematics control unit configured to transmit the data to a data processing system.

3. The method of claim 1, further comprising:
providing an initial incentive to the driver when the vehicle is provided and if the driver elects to participate in a monitoring program.

4. The method of claim 1, wherein the operational data comprises data of a driving style of the driver.

5. The method of claim 4, wherein the data of the driving style comprises acceleration and deceleration occurrences.

6. The method of claim 4, wherein the data of the driving style comprises highway driving information and city driving information.

7. The method of claim 4, wherein the data of the driving style comprises night time driving information and day time driving information.

8. The method of claim 4, wherein the data of the driving style comprises occurrences of turning the vehicle on and turning the vehicle off.

9. The method of claim 4, wherein the data of the driving style comprises data representing excessive lateral acceleration.

10. The method of claim 4, wherein the data of the driving style comprises data relating to erratic steering of a steering wheel of the vehicle.

11. The method of claim 4, wherein the data of the driving style comprises a number of miles driven.

12. The method of claim 1, wherein the operational data comprises vehicle system history and maintenance data.

13. The method of claim 12, wherein the vehicle maintenance data comprises non-routine maintenance records of the vehicle.

14. The method of claim 12, wherein the vehicle system history comprises non-routine maintenance history of similar vehicles.

15. The method of claim 12, wherein the vehicle system history comprises occurrences of warning indicators and a period of time each warning indicator is activated.

16. The method of claim 1, wherein providing the incentive or penalty comprises providing the incentive if the updated vehicle condition is better than the base vehicle condition and providing the penalty if the updated vehicle condition is worse than the base vehicle condition.

17. The method of claim 16, wherein the incentive is a reduction in a periodic payment owed by the driver for the vehicle and the penalty is an increase in the periodic payment.

18. The method of claim 1, wherein manipulating the operational data comprises:
weighting the operational data based on a category to which the operational data is assigned;
combining the weighted operational data in each category to determine one vehicle condition value per category;
extrapolating the vehicle condition value in each category to the end of the term; and
combining the extrapolated vehicle condition value in each category to arrive at the updated vehicle condition.

19. The method of claim 18, wherein providing the incentive or penalty comprises:
calculating an extrapolated residual value of the vehicle using the updated vehicle condition; and
calculating a change in a payment owed by the driver based on the extrapolated residual value of the vehicle.

20. An apparatus for monitoring a vehicle provided to a driver for a term, the apparatus comprising:
a memory; and
a processor configured to execute instructions stored in the memory to:
collect operational data of the vehicle during the term;
manipulate the operational data of the vehicle periodically throughout the term to arrive at an updated vehicle condition; and
provide an incentive or a penalty to the driver based on the updated vehicle.
